(19) United States
(12) Patent Application Publication
(10) Pub. No.: US 2020/0270733 A1
(43) Pub. Date: Aug. 27, 2020

(54) HIGH VELOCITY AIR FUEL (HVAF) COATED RADIAL BEARINGS

(71) Applicant: Schlumberger Technology Corporation, Sugar Land, TX (US)

(72) Inventor: Kinzie Elizabeth Verdell, Katy, TX (US)

(21) Appl. No.: 16/800,901

(22) Filed: Feb. 25, 2020

Related U.S. Application Data
(60) Provisional application No. 62/810,760, filed on Feb. 26, 2019.

(51) Int. Cl. C23C 4/12; E21B 4/00; E21B 4/02; F16C 33/12; C23C 4/10; C23C 4/18; C23C 28/04

(52) U.S. Cl. CPC C23C 4/12; E21B 4/003; E21B 4/02; E21B 7/06; C23C 4/10; C23C 4/18; C23C 28/04; F16C 33/121

(57) ABSTRACT

Systems and methods presented herein relate to depositing a material coating on a substrate. For example, first layer of a material coating is deposited upon a substrate using a thermal spray. Further, a cooling flow is provided to the substrate. Additionally, a second layer of the material coating is deposited upon the substrate subsequent to depositing the first layer using the thermal spray.

### CROSS-REFERENCE TO RELATED APPLICATION

This application claims priority to and the benefit of U.S. Provisional Application No. 62/810,760, entitled “High Velocity Air Fuel (HVAF) Coated Radial Bearings,” filed Feb. 26, 2019, which is hereby incorporated by reference in its entirety for all purposes.

### BACKGROUND

The present disclosure generally relates to downhole tools for drilling operations. More specifically, the present disclosure relates to techniques for depositing corrosion and abrasion resistant coatings on components of the downhole tools.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

Brazed coatings are relatively thin and highly wear-resistant coatings that can be applied to a wide range of substrates. Certain brazed coatings conform to a shape of a component, such as a radial bearing of a drilling motor, and form a metallurgical bond with a surface of the component in contact with the brazed coating. Certain conventional processes for applying brazed coatings are relatively time consuming. Additionally, certain conventional coating processes also suffer from cracking in the final cloth, and from being overly manual-intensive, thereby preventing uniform thickness over surfaces of large parts such as bearings. Further, conventional processes can lead to a complex inventory system to manage the various steps before obtaining a final product.

### SUMMARY

A summary of certain embodiments described herein is set forth below. It should be understood that these aspects are presented merely to provide the reader with a brief summary of these certain embodiments and that these aspects are not intended to limit the scope of this disclosure.

Certain embodiments of the present disclosure include a method. The method includes depositing a first layer of a material coating upon a substrate using a thermal spray device. The method also includes providing a cooling flow to the substrate via a cooling jet. Further, the method includes depositing a second layer of the material coating upon the substrate using the thermal spray device, wherein the second layer is deposited subsequent to depositing the first layer.

In addition, certain embodiments of the present disclosure include an additional method. The additional method includes depositing a first layer of a material coating upon a radial bearing using a thermal spray device. The additional method also includes providing a cooling flow to the radial bearing. Further, the method includes depositing a second layer of the material coating upon the radial bearing using the thermal spray device, wherein the second layer is deposited subsequent to depositing the first layer.

In addition, certain embodiments of the present disclosure include a system. The system includes a high velocity air fuel (HVAF) thermal spray device that provides a material spray to a radial bearing to form a material coated radial bearing. The system also includes a cooling jet that provides a cooling flow of fluid to the radial bearing. Further, the system includes a rotational actuator that rotates the radial bearing. Further still, the system includes a controller communicatively coupled to the rotational actuator, the HVAF thermal spray device, and the cooling jet. The controller may send a first control signal to the HVAF thermal spray device to provide the material spray. The controller may also send a second control signal to the rotational actuator to cause the rotational actuator to perform a first rotation of the radial bearing. Further the controller may send a third control signal to cause the cooling jet to provide the cooling flow of the fluid. Further still, the controller may send a fourth control signal, subsequent to the second control signal, to cause the rotational actuator to perform a second rotation of the radial bearing.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings, in which:

FIG. 1 is a schematic view of at least a portion of an example implementation of a wellsite system, in accordance with embodiments of the present disclosure;

FIG. 2 is a block diagram of a downhole motor, in accordance with embodiments of the present disclosure;

FIG. 3 is a perspective view of a downhole motor, in accordance with embodiments of the present disclosure;

FIG. 4 is a cross-sectional perspective view of a downhole motor, in accordance with embodiments of the present disclosure;

FIG. 5 is a perspective view of an upper radial bearing of a bearing section of a downhole motor, in accordance with embodiments of the present disclosure;

FIG. 6 is a perspective view of a lower radial bearing of a bearing section of a downhole motor, in accordance with embodiments of the present disclosure;

FIG. 7A is a schematic diagram of a deposition system for applying a material coating using a thermal spray, in accordance with embodiments of the present disclosure;

FIG. 7B is an illustration of the material coating depositing upon a substrate due to the material spray impinging onto a surface of the substrate, in accordance with embodiments of the present disclosure;

FIG. 8 is a perspective view of the deposition system during deposition of the material coating onto a radial bearing, in accordance with embodiments of the present disclosure; and

FIG. 9 is a flow diagram illustrating a process for depositing a material coating onto a radial bearing and cooling the radial bearing, in accordance with embodiments of the present disclosure.

### DETAILED DESCRIPTION

One or more specific embodiments of the present disclosure will be described herein. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.” As used herein, the terms “up” and “down,” “uphole” and “downhole”, “upper” and “lower,” “top” and “bottom,” “above” and “below,” and other like terms indicating relative positions to a given point or element are utilized to more clearly describe some elements. Commonly, these terms relate to a reference point as the surface from which drilling operations are initiated as being the top (e.g., uphole or upper) point and the total depth along the drilling axis being the lowest (e.g., downhole or lower) point, whether the well (e.g., wellbore, borehole) is vertical, horizontal or slanted relative to the surface.

In the present context, the term “about” or “approximately” is intended to mean that the values indicated are not exact and the actual value may vary from those indicated in a manner that does not materially alter the operation concerned. For example, the term “about” or “approximately” as used herein is intended to convey a suitable value that is within a particular tolerance (e.g., ±10%, ±5%, ±1%, ±0.5%), as would be understood by one skilled in the art.

As mentioned above, brazed coatings may be applied to components used in drilling operations to improve the corrosion and abrasion resistance of the components during the drilling operations. Thermal spraying (e.g., high velocity air fuel (HVAF) spraying, high velocity oxygen fuel (HVOF) spraying, plasma spraying, wire frame spraying, and the like) may be used to deposit a coating upon a substrate using an at least partially solid particle precursor (e.g., a powder) for the coating. For example, an HVAF thermal spraying apparatus combusts fuel and air to produce a high pressure, hot gas, which is used to accelerate and heat the solid particle precursor provided to the HVAF thermal spraying apparatus. The heated and accelerated solid particle precursor is partially melted by way of the high pressure, hot gas and subsequently deposited upon the substrate. Certain thermal spraying techniques, such as HVAF thermal spraying, may operate controllably over a range of temperatures and/or velocities of the particles of the solid particle precursor, which enables precise and gradual heating of the solid particle precursor to, or approximately above, a melting temperature of the particles of the solid particle precursor, thereby preventing or blocking material oxidation, carbide decomposition, and other potential defects that may result in the coating deposited upon the substrate. However, conventional thermal spraying techniques may operate at temperatures that may damage certain substrates during the deposition, which may compromise the mechanical integrity of the substrate and/or the substrate with the coating.

Accordingly, the present disclosure generally relates to techniques for depositing a material coating to improve resistance to corrosion and abrasion of a substrate using thermal spraying with improved temperature control. As will be discussed in greater detail below, the coating may be deposited onto a substrate, such as an inner radial bearing and/or an outer radial bearing of a motor for a bottom hole assembly (BHA), using the disclosed deposition process. The disclosed deposition process generally includes one or more deposition steps using thermal spraying, one or more cooling steps and, at least in some instances, conclusion steps, such as polishing of the material coating deposited onto the substrate. By using thermal spraying in combination with the cooling steps, certain materials (e.g., carbides, such as tungsten carbides) may be deposited on various substrates with less material oxidation and precursor (e.g., carbide) decomposition, thereby providing a coating with more resistance to corrosion, higher hardness, and toughness. At least in some instances, coatings of the certain materials, such as certain carbides, may also provide approximately similar or better mechanical properties than coatings with materials applied by certain conventional deposition techniques in addition to being thinner. In this way, the disclosed techniques may reduce costs associated with coating substrates by using less material. Additionally, the disclosed techniques may have a decreased lead time over certain conventional substrate coating processes, such as “cloth” coating of radial bearings for drilling rigs and the like. For example, the disclosed techniques may be performed without furnace treatment, heat treatments, or post heat treat inspections, which would otherwise add additional time (e.g., approximately 1 day, 2 days, 1 week, or even more) to the process of applying the material coating. Moreover, the disclosed techniques may enable a deposition process to be at least partially automated, which may further reduce costs.

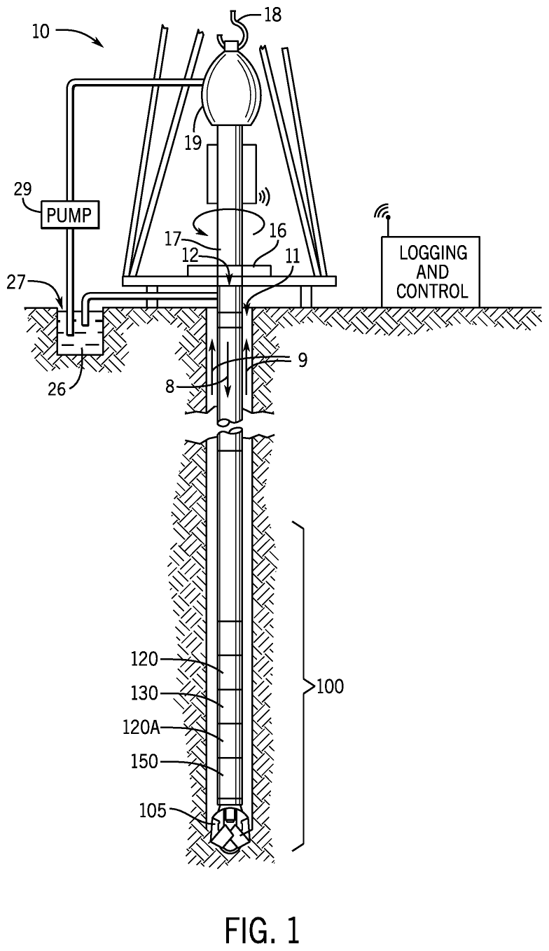

With this in mind, FIG. 1 illustrates a wellsite system in which embodiments of the present disclosure may be employed. The wellsite may be onshore or offshore. As illustrated in FIG. 1, a borehole 11 may be formed in subsurface formations by drilling. The method of drilling to form the borehole 11 may include, but is not limited to, rotary and directional drilling. In certain embodiments, a drill string 12 is suspended within the borehole 11 and has a bottom hole assembly (BHA) 100 that includes a drill bit 105 at its lower end.

In certain embodiments, the surface system includes a platform and derrick assembly 10 positioned over the borehole 11. In certain embodiments, the platform and derrick assembly 10 may include a rotary table 16, a kelly 17, a hook 18 and a rotary swivel 19. The drill string 12 may be rotated by the rotary table 16, energized by means (not shown) which engages the kelly 17 at the upper end of the drill string 12. In certain embodiments, the drill string 12 may be suspended from the hook 18, attached to a traveling block (not shown) through the kelly 17 and the rotary swivel 19, which permits rotation of the drill string 12 relative to the hook 18. A top drive system could alternatively be used in other embodiments.

In certain embodiments, the surface system also includes a drilling fluid 26 (e.g., mud) stored in a pit 27 formed at the wellsite. In certain embodiments, a pump 29 delivers the drilling fluid 26 to the interior of the drill string 12 via one or more ports in the swivel 19, causing the drilling fluid to flow downwardly through the drill string 12, as indicated by directional arrow 8. The drilling fluid exits the drill string 12 via one or more ports in the drill bit 105, and then circulates upwardly through an annular region between the outside of the drill string 12 and the wall of the borehole 11, as indicated by directional arrows 9. In this manner, the drilling fluid lubricates the drill bit 105 and carries formation cuttings and particulate matter up to the surface as it is returned to the pit 27 for recirculation.

In other embodiments, the wellsite system may be used in a reverse circulation application in which the pump 29 delivers the drilling fluid 26 to the annular region formed between the outside of the drill string 12 and drill bit 105 and the wall of the borehole 11, causing the drilling fluid to flow downwardly through the annular region. In such embodiments, the drilling fluid is returned to the surface by being pumped upwardly through the interior of the drill string 12.

In certain embodiments, a bottom hole assembly 100 includes one or more logging-while-drilling (LWD) modules 120/120A, one or more measuring-while-drilling (MWD) modules 130, one or more rotary-steerable systems and motors (not shown), and the drill bit 105. It will also be understood that more than one LWD module and/or more than one MWD module may be employed in one embodiment (e.g. as represented at 120 and 120A). In certain embodiments, the LWD module 120/120A may be housed in a special type of drill collar, and may be capable of measuring, processing, and storing information, as well as for communicating with the surface equipment. In certain embodiments, the LWD module 120/120A may also include a pressure measuring device and one or more logging tools.

In certain embodiments, the MWD module 130 may be housed in a special type of drill collar, and may include one or more devices for measuring characteristics of the drill string 12 and drill bit 105. In certain embodiments, the MWD module 130 may also include one or more devices for generating electrical power for the downhole system. In certain embodiments, the power generating devices include a mud turbine generator (also known as a “mud motor”) powered by the flow of the drilling fluid. In other embodiments, other power and/or battery systems may be employed to generate power. In certain embodiments, the MWD module 130 may also include one or more of the following types of measuring devices: a weight-on-bit measuring device, a torque measuring device, a vibration measuring device, a shock measuring device, a stick slip measuring device, a direction measuring device, and an inclination measuring device.

A particularly advantageous use of the wellsite system of FIG. 1 is in conjunction with controlled steering or “directional drilling.” Directional drilling is the intentional deviation of the wellbore from the path it would naturally take. In other words, directional drilling is the steering of the drill string 12 so that it travels in a desired direction. Directional drilling is, for example, advantageous in offshore drilling because it enables multiple wells to be drilled from a single platform. Directional drilling also enables horizontal drilling through a reservoir. Horizontal drilling enables a longer length of the wellbore to traverse the reservoir, which increases the production rate from the well. A directional drilling system may also be used in vertical drilling operation. Often, the drill bit may veer off of a planned drilling trajectory because of the unpredictable nature of the formations being penetrated or the varying forces that the drill bit experiences. When such a deviation occurs, a directional drilling system may be used to put the drill bit back on course.

A known method of directional drilling includes the use of a rotary steerable system (“RSS”). In an embodiment that employs the wellsite system of FIG. 1 for directional drilling, a rotary-steerable subsystem 150 is provided. In an exemplary RSS, the drill string is rotated from the surface, and downhole devices cause the drill bit to drill in the desired direction. Rotating the drill string greatly reduces the occurrences of the drill string getting hung up or stuck during drilling. Rotary steerable drilling systems for drilling deviated boreholes into the earth may be generally classified as either “point-the-bit” systems or “push-the-bit” systems.

In an exemplary “point-the-bit” rotary steerable system, the axis of rotation of the drill bit is deviated from the local axis of the bottom hole assembly in the general direction of the new hole. The hole is propagated in accordance with the customary three-point geometry defined by upper and lower stabilizer touch points and the drill bit. The angle of deviation of the drill bit axis coupled with a finite distance between the drill bit and lower stabilizer results in the non-collinear condition required for a curve to be generated. This may be achieved in a number of different ways, including a fixed bend at a point in the bottom hole assembly close to the lower stabilizer or a flexure of the drill bit drive shaft distributed between the upper and lower stabilizers. In its idealized form, the drill bit is not required to cut sideways because the bit axis is continually rotated in the direction of the curved hole.

In an exemplary “push-the-bit” rotary steerable system, there is no specially identified mechanism that deviates the bit axis from the local bottom hole assembly axis. Instead, the requisite non-collinear condition is achieved by causing either or both of the upper or lower stabilizers to apply an eccentric force or displacement in a direction that is preferentially orientated with respect to the direction of hole propagation. This may be achieved in a number of different ways, including non-rotating (with respect to the hole) eccentric stabilizers (displacement based approaches) and eccentric actuators that apply force to the drill bit in the desired steering direction. Steering is achieved by creating non co-linearity between the drill bit and at least two other touch points. In its idealized form, the drill bit is required to cut sideways in order to generate a curved hole.

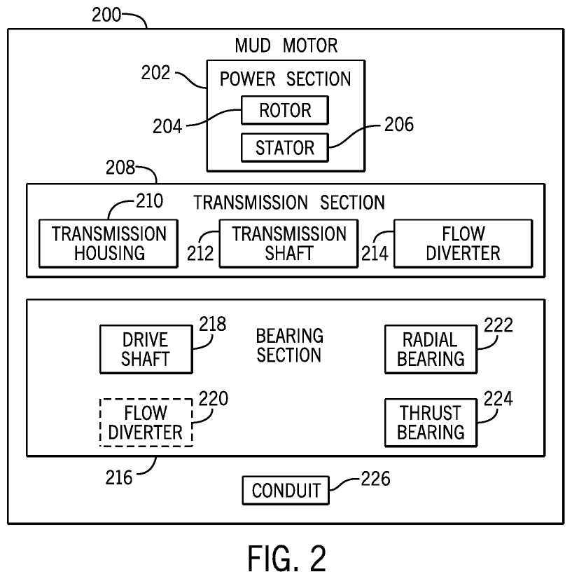

FIG. 2 is a block diagram of a downhole (e.g., mud) motor 200. As illustrated, in certain embodiments, the downhole motor 200 includes a power section 202 that converts hydraulic energy of the drilling fluid into mechanical rotary energy, a transmission section 208 that transfers the mechanical rotary drive generated by the power section 202 to a drive shaft, and a bearing section 216 that supports axial and radial loads of the drive shaft during drilling as it transfers the mechanical rotary energy generated by the power section 202 to a downhole tool.

In certain embodiments, the power section 202 of the downhole motor 200 may include a helical rotor 204 rotatably disposed within the longitudinal bore of a helical stator 206. The downhole motor 200 may be fabricated in a variety of configurations. Generally, when viewed cross-sectionally, the rotor 204 has nᵣ lobes and the stator 206 has nₛ lobes, wherein nₛ=nᵣ+1. In operation, the helical formation on the rotor 204 seals tightly against the helical formation of the stator 206 as the rotor 204 rotates to form a set of cavities in between. The drilling fluid flows in the cavities. The hydraulic pressure of the drilling fluid causes the cavities to progress axially along the longitudinal axis of the power section, and causes a relative rotation between the rotor 204 and the stator 206 about the longitudinal axis.

In certain embodiments, the transmission section 208 of the downhole motor 200 includes a transmission housing 210 that encloses and houses a transmission shaft 212 and a hollow central passage through which the drilling fluid may flow in a radial manner. The transmission shaft 212 is connected to the rotating rotor 204 of the power section 202 and to the drive shaft 218 of the bearing section 216. The transmission shaft 212 conveys the rotary and axial drives generated by the power section 202 to the drive shaft 218 of the bearing section 216. In certain embodiments, a flow diverter 214 may be provided in the transmission section 208 (e.g., disposed or formed in the transmission shaft 212) to divert the flow of the drilling fluid from an axial flow through the hollow central passage of the transmission section 208 to a radial flow through the hollow central passage of the drive shaft 218.

In certain embodiments, the bearing section 216 of the downhole motor 200 includes a drive shaft 218 that includes a hollow central passage through which the drilling fluid may flow in a radial manner. The drive shaft 218 transfers the mechanical rotary energy transmitted by the transmission section 208 to one or more downhole tools (e.g., a drill bit 105). The bearing section 216 includes a set of radial bearings 222 that supports radial loads during drilling and a set of thrust bearings 224 that supports axial loads during drilling. In certain embodiments, a flow diverter 220 may be provided in the bearing section 216 (e.g., disposed or formed in the drive shaft 218) to divert the flow of the drilling fluid from an axial flow through the hollow central passage of the transmission section 208 to a radial flow through the hollow central passage of the drive shaft 218. In certain embodiments, the downhole motor 200 includes one or more transmission cables 226 that run through one or more sections of the downhole motor 200.

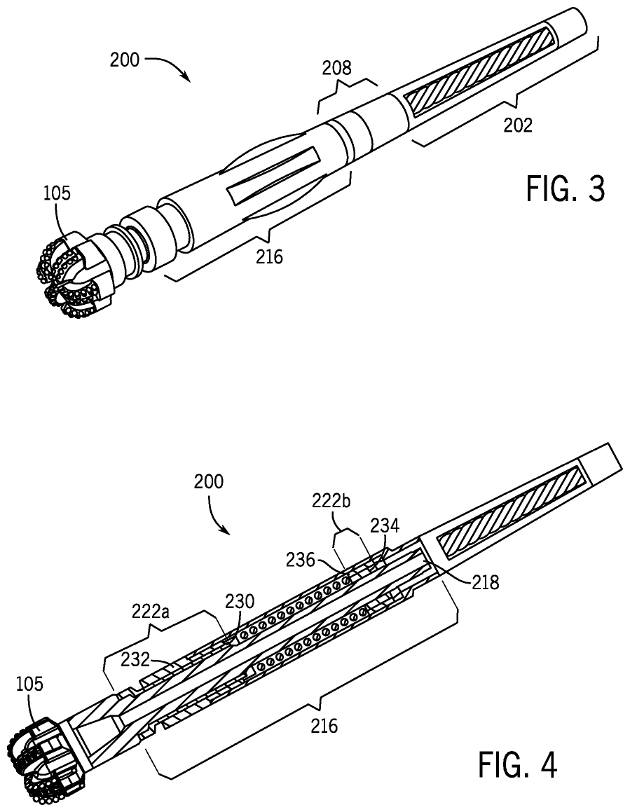

FIG. 3 is a perspective view of an illustrated embodiment of the downhole motor 200 that includes a power section 202, a transmission section 208, and a bearing section 216, which cooperate to drive the drill bit 105, as described herein. As also described herein, in certain embodiments, the bearing section 216 includes a set of radial bearings 222 that support radial loads during drilling. To illustrate an example of the positioning of the radial bearings 222 within the bearing section 216, FIG. 4 is a cross-sectional perspective view of the illustrated embodiment of the bearing section 216 of the downhole motor 200 shown in FIG. 3 with two sets of radial bearings 222. While only two sets of radial bearings 222 (e.g., a first set of radial bearings 222a and a second set of radial bearings 222b) are shown in the illustrated embodiment, it should be appreciated that the illustrated number of sets of radial bearings is non-limiting and may include fewer or more sets of radial bearings 222.

In certain embodiments, each set of radial bearings 222 (e.g., the first set of radial bearings 222a and the second set of radial bearings 222b) generally includes an inner radial bearing and an outer radial bearing that interact with each other. For example, the first set of radial bearings 222a, which is disposed downhole from (e.g., lower than) the second set of radial bearings, includes a lower inner radial bearing 230 and a lower outer radial bearing 232. In addition, the second set of radial bearings 222b, which is disposed upstream of (e.g., above) the first set of radial bearings 222a, includes an upper inner radial bearing 234 and an upper outer radial bearing 236. In general, each set of inner and outer radial bearings (e.g., the first set of radial bearings 222a including the lower inner radial bearing 230 and the lower outer radial bearing 232 and the second set of radial bearings 222b including the upper inner radial bearing 234 and the upper outer radial bearing 236) are configured to rotate relative to each other to support rotation of the drive shaft 218.

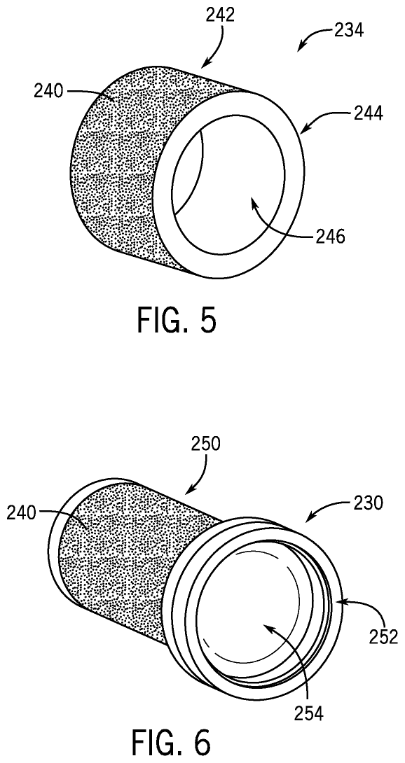

As described in greater detail below with respect to FIGS. 5-8, any combination of the lower inner radial bearing 230, the lower outer radial bearing 232, the upper inner radial bearing 234, and the upper outer radial bearing 236 may have a material coating deposited onto at least one surface. For example, FIG. 5 is a perspective view of the upper inner radial bearing 234 having a material coating 240 deposited onto an outer surface 242 of the upper inner radial bearing 234. While the illustrated embodiment shows the material coating 240 deposited on only the outer surface 242 of the upper inner radial bearing 234, it should be appreciated that the material coating 240 may also be deposited on, or at least partially deposited on, axial end surfaces 244 and/or an inner surface 246 of the upper inner radial bearing 234. Moreover, as the material coating 240 is shown as being a single layer onto the outer surface 242, in other embodiments, the material coating 240 may be formed from multiple (e.g., 2, 3, 4, 5, 6, or even more) layers that are each deposited during a deposition step (or multiple deposition steps), as described in greater detail with respect to FIG. 9, for example. It should be noted that the material coating 240 may also be deposited onto an outer surface, an inner surface, and/or axial end surfaces of the upper outer radial bearing 236.

Similarly, FIG. 6 is a perspective view of a lower inner radial bearing 230 having a material coating 240 deposited onto an outer surface 250 of the lower inner radial bearing 230. While the illustrated embodiment shows the material coating 240 deposited on only the outer surface 250 of the lower inner radial bearing 230, it should be appreciated that the material coating 240 may also be deposited on, or at least partially deposited on, axial end surfaces 252 and/or an inner surface 254 of the lower inner radial bearing 230. Moreover, as the material coating 240 is shown as being a single layer onto the outer surface 250, in other embodiments, the material coating 240 may be formed from multiple (e.g., 2, 3, 4, 5, 6, or even more) layers that are each deposited during a deposition step (or multiple deposition steps), as described in greater detail with respect to FIG. 9, for example. It should be noted that the material coating 240 may also be deposited onto an outer surface, an inner surface, and/or axial end surfaces of the lower outer radial bearing 232.

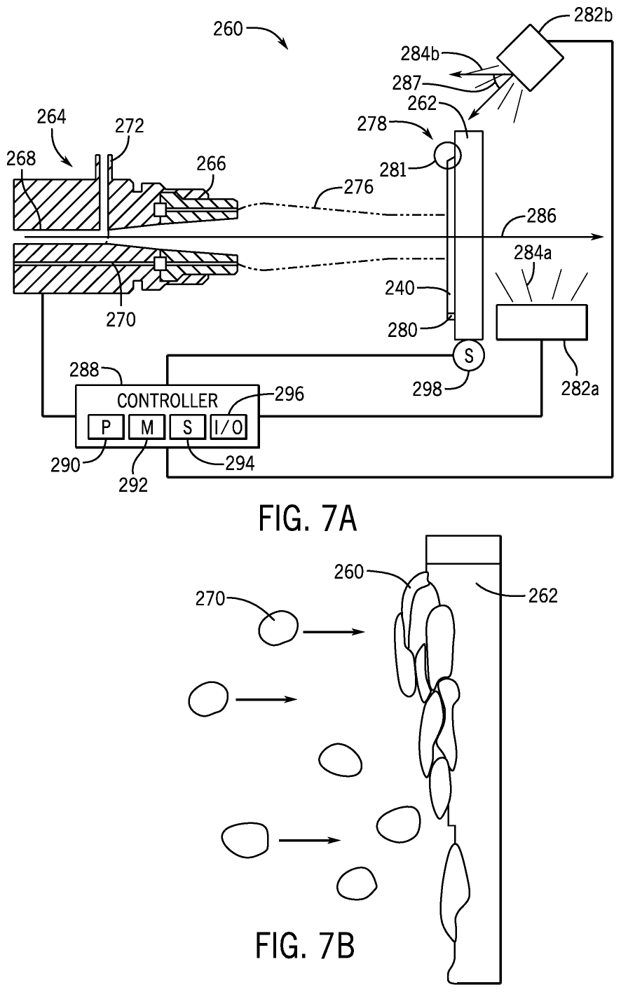

FIG. 7A is a schematic diagram of a deposition system 260 during a deposition process to apply the material coating 240 onto a surface of a substrate 262 (e.g., a radial bearing, in certain embodiments), in accordance with embodiments of the present disclosure. As illustrated, in certain embodiments, the deposition system 260 includes a thermal spray device 264 having a nozzle 266 at an axial end of the thermal spray device 264, a fuel gas channel 268 extending axially through the thermal spray device 264 generally along a central axis 286 of the thermal spray device 264, one or more air channels 270 extending axially through the thermal spray device 264 and the nozzle 266 radially offset from the central axis 286 of the thermal spray device 264, and a material coating precursor inlet 272 extending radially inward through the thermal spray device 264 to the fuel gas channel 268. The thermal spray device 264 is described herein as being an HVAF thermal spray device insofar air as is mixed with fuel. Some embodiments of the thermal spray device 264 may be available through Kermetico of Benicia, California. However, in other embodiments, the thermal spray device 264 may be an HVOF thermal spray device insofar as oxygen, instead of air, may be mixed with fuel.

In operation, air (or oxygen, in certain embodiments) is provided to the air channel(s) 270 (e.g., via an air inlet) and fuel (e.g., liquid and/or gas fuel, such as kerosene, hydrogen, methane, propane, propylene, acetylene, natural gas, and the like)) is provided to the fuel gas channel 268 (e.g., via a fuel inlet), where the air and fuel are mixed and subsequently ignited (e.g., via an ignition source, such as an ignition plug, within the nozzle 266, in certain embodiments) and combusted to produce a high pressure (e.g., less than or approximately equal to 1 MPa) and hot (e.g., approximately 1500° C.) gas. Additionally, the material coating precursor (e.g., tungsten carbide, in certain embodiments) is provided to the material coating precursor inlet 272 (e.g., as a solid particle powder, in certain embodiments) to be added to the fuel gas stream upstream of the nozzle 266, which produces is a high pressure and hot gas from the resulting combusting air, fuel, and powder mixture. The material coating precursor, when in contact with the high pressure and hot gas, is accelerated to a high velocity (e.g., between approximately 1000 m/s to 1500 m/s, in certain embodiments) and may be at least partially melted, produces a material spray 276 that exits out of the nozzle 266, and deposits onto a surface 278 of the substrate 262 (e.g., the surfaces 242, 244, 246, 250, 252, 254 of the radial bearings 234, 230 illustrated in FIGS. 5 and 6, for example) to produce the material coating 240 having a thickness 280. To further illustrate this, FIG. 7B is an illustration of the material coating 240 depositing upon the substrate 262 due to the material spray 276 impinging onto the surface of the substrate 262 (e.g., corresponding to region 281, in accordance with embodiments of the present disclosure.

The material coating precursor may comprise any material with a suitable melting temperature to operate using the thermal spray process. For example, the material coating precursor used for the radial bearings 222 may be a blend of tungsten carbide cobalt, such as 88-12 tungsten carbide cobalt (e.g. approximately 88% tungsten carbide and approximately 12% cobalt), which is generally harder than the 86-10-4 tungsten carbide nickel chrome that may be used for the rotors. While tungsten carbide is described herein as an example of the material coating precursor, it should be noted that other metal carbides or metal carbide blends may be used, such as titanium carbide, tungsten carbide cobalt, and other various alloys, eutectic alloys, and the like. At least in some embodiments, the material used for the material coating precursor may be dependent on the thermal expansion coefficient of the resulting material coating 240 and the thermal expansion coefficient of the substrate 262. For example, the material of the rotors may include a 17-4 stainless steel which can withstand relatively high temperatures (e.g., up to approximately 1400° C.) while material of the radial bearings 222 may include a 4140 steel that is cheaper than the 17-4 stainless steel, yet may be negatively affected by relatively high temperatures. As such, it may be advantageous to cool the radial bearings 222 before, during, and/or after deposition of the material coating 240 to maintain the temperature of the radial bearings 222 below a temperature threshold (e.g., approximately 100° C., approximately 200° C., approximately 250° C., approximately 300° C., approximately 400° C., and approximately 500° C., in certain embodiments). Maintaining the temperature of the radial bearings 222 below a temperature threshold may reduce or eliminate thermal effects, such as shape distortion, cracks, material property changes (e.g., annealing, stress relieving, normalizing), or any combination thereof.

The illustrated embodiment of the deposition system 260 also includes one or more substrate cooling devices 282 (e.g., cooling jets). As shown, in certain embodiments, the one or more substrate cooling devices 282 may be disposed near (e.g., within a few inches) the substrate 262 and are arranged to provide a cooling flow 284 of a fluid (e.g., air, water, or any combination thereof) to cool the surface 278 of the substrate 262 and/or the material coating 240. In some embodiments, the substrate cooling devices 282 are arranged to provide a cooling flow 284 to directly cool the substrate 262 and to indirectly cool the surface 278 with the material coating 240. Additionally or alternatively, the substrate cooling devices 282 may be arranged to provide the cool flow 284 to directly cool the surface 278 with the material coating 240 and to indirectly cool the substrate 262. For example, the substrate cool devices 282 may be positioned on approximately the same side as the thermal spray device 264 relative to the substrate 262. The positions of the substrate cooling devices 282 illustrated in FIG. 7A are intended to be non-limiting, illustrative examples of positions and arrangements of the one or more substrate cooling devices 282 relative to the substrate 262. For example, a first substrate cooling device 282a produces a first cooling flow 284a that is approximately perpendicular (e.g., within a few degrees of being exactly perpendicular) to a central axis 286 of the substrate 262, whereas a second substrate cooling device 282b produces a second cooling flow 284b at an angle 287 less than the central axis 286 (e.g., 10 degrees, 20 degrees, 30, degrees, 40 degrees, 50 degrees, 60 degrees, etc.). It should be noted that the one or more substrate cooling devices 282 may be positioned in any number of arrangements corresponding to the substrate cooling device 282a and/or 282b. For example, a single substrate cooling device 282 may be arranged to provide a cooling flow 284 that is approximately equal to or less than 90 degrees from the central axis 286 of the substrate 262. In addition, in certain embodiments, an additional substrate cooling device 282 may be arranged to provide a cooling flow 284 in a direction that is opposite (e.g., 180 degrees) of the cooling flow 284 of the substrate cooling device 282a. In certain embodiments, multiple substrate cooling devices 282 may be arranged to provide respective cooling flows 284 in approximately the same direction.

In certain embodiments, the operation of the deposition system 260 may be at least partially controlled by a controller 288 having a processor 290, which may execute instructions stored in memory 292 and/or storage media 294, or based on inputs provided from a user via the input/output (I/O) device 296. The memory 292 and/or the storage media 294 may be read-only memory (ROM), random-access memory (RAM), flash memory, an optical storage medium, or a hard disk drive, to name but a few examples. For example, in operation, the processor 290 may send suitable control signals to actuate valves that may enable air, fuel, and/or solid material precursor to be provided to the fuel gas channel 268, the air channel 270, and/or the material coating precursor inlet 272. In certain embodiments, the controller 288 may also send suitable control signals to the one or more substrate cooling devices 282 to control the rate and/or amount of cooling flow 284 provided to the substrate 262 and/or the material coating 240, as described in greater detail with respect to FIG. 9. In certain embodiments, the controller 288 may function to regulate operation of the thermal spray device 264 and/or the substrate cooling devices 282 based on feedback from an operator (e.g., via the I/O devices 296) and/or from sensors 298 (e.g., temperature sensors) that may detect a temperature of the substrate 262. While FIG. 7A is described with respect to the substrate 262, it should be noted that the deposition system 260 may also be used to deposit the material coating 240 onto a multi-directional surface (e.g., cylinder, box, and the like).

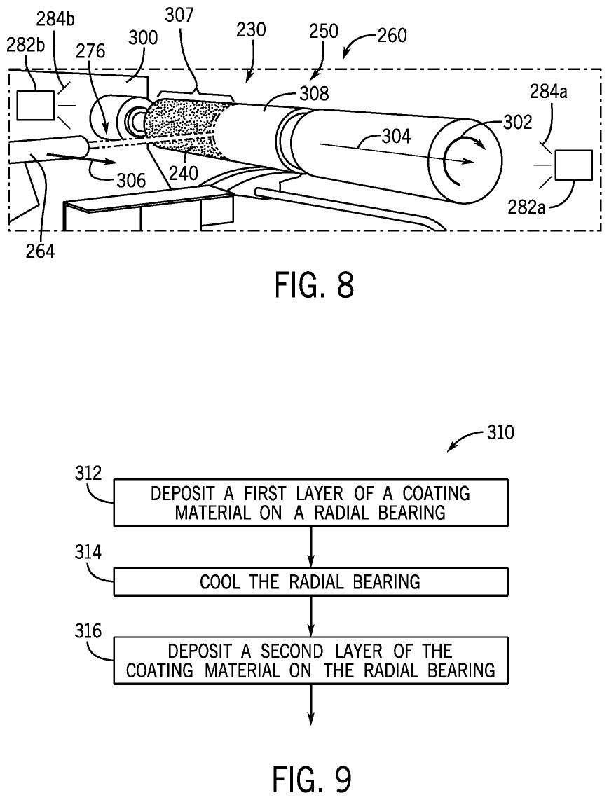

FIG. 8 is a perspective view of the deposition system 260 during deposition of the material coating 240 upon the outer surface 250 of a lower inner radial bearing 230, in accordance with embodiments of the present disclosure. As illustrated, in certain embodiments, the deposition system 260 of FIG. 8 includes a thermal spray device 264, substrate cooling devices 282, and a rotation actuator 300. The thermal spray device 264 is described herein as being an HVAF thermal spray device insofar air as is mixed with fuel. Some embodiments of the thermal spray device 264 may be available through Kermetico of Benicia, Calif. However, in other embodiments, the thermal spray device 264 may be an HVOF thermal spray device insofar as oxygen, instead of air, may be mixed with fuel.

In operation, the thermal spray device 264 produces a material spray 276 that deposits the material coating 240 onto the outer surface 250 of the lower inner radial bearing 230. The rotation actuator 300 may rotate the lower inner radial bearing 230 in a direction 302 about the central axis 304 so that the outer surface 250 surrounding the lower inner radial bearing 230 may be coated. Additionally or alternatively, the thermal spray device 264 may translate axially (e.g., via a linear actuator) along the central axis 304 in the direction 306. It should be appreciated that rotating the lower inner radial bearing 230 and translating the thermal spray device 264, whether separately or in conjunction, may facilitate coating the surface of a three-dimensional structure of the lower inner radial bearing 230. For example, as shown in the illustrated embodiment, a portion 307 of the outer surface 250 of the lower radial bearing 230 is coated with the material coating 240. As the lower inner radial bearing 230 continues to rotate (e.g., in the direction 302) and the thermal spray device 264 continues to translate in the direction 306 and the uncoated portion 308 will be coated with the coating material 240. It should be noted that, at least in some instances, the lower inner radial bearing 230 and/or the thermal spray device 264 may be configured to rotate and/or translate axially. Additionally, while the direction 302 of the rotation is shown as being clockwise, it should be noted that the direction 302 may also be counter clockwise. Furthermore, it should be noted that, in certain embodiments, a controller (e.g., the controller 288 as discussed above with respect to FIG. 7A) may function to control operation of the rotation actuator 300 and/or axial translation of the thermal spray device 264.

The illustrated embodiment of the deposition system 260 in FIG. 8 also includes one or more substrate cooling devices 282 (e.g., cooling jets). As shown, in certain embodiments, the one or more substrate cooling devices 282 may be disposed near (e.g., within a few inches) the lower inner radial bearing 230 and are arranged to provide a cooling flow 284 of a fluid (e.g., air, water, or any combination thereof) to cool the surface 250 of the lower inner radial bearing 230 and/or the material coating 240. In some embodiments, the substrate cooling devices 282 are arranged to provide a cooling flow 284 to directly cool the lower inner radial bearing 230 and to indirectly cool the outer surface 250 with the material coating 240. Additionally or alternatively, the substrate cooling devices 282 may be arranged to provide the cooling flow 284 to directly cool the outer surface 250 with the material coating 240 and to indirectly cool the lower inner radial bearing 230. For example, the substrate cooling devices 282 may be positioned on approximately the same side as the thermal spray device 264 relative to the substrate 262. The positions of the substrate cooling devices 282 illustrated in FIG. 8 are intended to be non-limiting, illustrative examples of positions and arrangements of the one or more substrate cooling devices 282 relative to the substrate 262. For example, a first substrate cooling device 282a produces a first cooling flow 284a that is approximately parallel (e.g., within a few degrees of being exactly parallel) to the central axis 304 of the lower inner radial bearing 230. Moreover, the first substrate cooling device 282a provides the first cooling flow 284a to the inner surface (e.g., inner surface 254 as shown in FIG. 6) of the lower inner radial bearing 230. A second substrate cooling device 282b provides a second cooling flow 284b to the outer surface 250 of the lower inner radial bearing 230. It should be noted that the one or more substrate cooling devices 282 may be positioned in any number of arrangements corresponding to the substrate cooling device 282a and/or 282b. For example, a single substrate cooling device 282 may be arranged to provide a cooling flow 284 that is approximately equal to or less than 90 degrees from the longitudinal axis 304 of the substrate 262. In addition, in certain embodiments, an additional substrate cooling device 282 may be arranged to provide a cooling flow 284 in a direction that is opposite (e.g., 180 degrees) of the cooling flow 284 of the substrate cooling device 282a. In certain embodiments, multiple substrate cooling devices 282 may be arranged to provide respective cooling flows 284 in approximately the same direction.

In some embodiments, the first substrate cooling device 282a and/or second substrate cooling device 282b may be arranged to provide the cooling flow 284 to the portion 307 of the outer surface 250 that is coated with the material coating 240. For example, the first substrate cooling device 282a and/or second substrate cooling device 282b may be configured to translate along the central axis 304 (e.g., approximately in the same direction as direction 306) so that the first substrate cooling device 282a and/or second substrate cooling device 282b may cool the portion 307 of the outer surface 250 that is coating the material coating 240.

FIG. 9 is a flow diagram of a process 310 for depositing a material coating 240 onto the substrate 262, in accordance with embodiments of the present disclosure. In the illustrated embodiment, the process 310 generally includes depositing a first layer of a material coating 240 upon a radial bearing 222 using a thermal spraying device 264 (block 312), cooling the radial bearing 222 and/or the material coating 240 (block 314) using one or more substrate cooling devices 282, and a depositing a second layer of the material coating 240 upon the radial bearing 222 using the thermal spraying device 264 (block 316). As may be appreciated, the same process 310 may be used to deposit a material coating 240 onto the substrate 262, the lower inner radial bearing 230, the lower outer radial bearing 232, the upper inner radial bearing 234, and the upper outer radial bearing 236. Moreover, in certain embodiments, at least a portion of the process 310 may be controlled via the processor 290 of the controller 288.

Depositing the first layer of the material coating 240 may include adding a material coating precursor powder (e.g., tungsten, carbide, cobalt-based powder) to a fuel gas near the nozzle 266 of the thermal spraying device 264, adding air (or oxygen) to the powder and fuel gas mixture at the nozzle 266 of the thermal spraying device 264, and impinging the oxygen and fuel gas mixture upon a surface of the substrate 262. In certain embodiments, depositing a first layer of a material coating 240 upon the radial bearing 222 using the thermal spraying device 264 (block 312) may include depositing a coating for a predetermined time and/or to achieve a predetermined thickness. For example, an operator may desire a thickness 280 of the material coating 240, such as between approximately 0.008″ to approximately 0.010″. Accordingly, the thermal spraying device 264 may produce the material spray 276 for a predetermined time to achieve the desired thickness 280. It should be noted that the predetermined time of applying the material spray 276 using the thermal spraying device 264 may be based on prior knowledge and experience by the operator and/or stored in a look up table (e.g., in the memory 292 and/or storage media 294). In certain embodiments, the radial bearing 222 may be rotating (e.g., via the rotational actuator 300) while the thermal spraying device 264 is depositing the material coating 240 onto the radial bearing 222. As such, the predetermined time may be based at least in part on a rate at which the radial bearing 222 is rotating.

Additionally or alternatively, depositing the first layer of the material coating 240 upon the radial bearing 222 using the thermal spraying device 264 may include depositing the material coating 240 for a predetermined time so that the temperature of the radial bearing 222 does not exceed a temperature threshold. For example, the predetermined time of applying the material spray 276 using the thermal spraying device 264 may be based on prior knowledge and experience by the operator and/or stored in a look up table (e.g., in the memory 292 and/or storage media 294).

In certain embodiments, depositing the first layer of the material coating 240 may include measuring a temperature of the radial bearing 222 using a temperature sensor 298. For example, the temperature sensor 298 may be in contact with a surface (e.g., the inner surface 246, the outer surface 242, and/or the axial end surface 244 of the upper inner radial bearing 234 as described in FIG. 5, for example) and obtain temperature measurements indicative of the temperature of the surface, which are subsequently received by the processor 290 of the controller 288. In response to receiving a measured temperature, the processor 290 may make a determination of whether to modify an operation of the deposition system 260 based on the measured temperature being above or below a temperature threshold and/or temperature threshold range. For example, when the measured temperature is above a temperature threshold range, the processor 290 may output a control signal to the thermal spraying device 264 that causes the thermal spraying device 264 to stop operation. In certain embodiments, the processor 290 may output a control signal that alerts an operator that the temperature is outside of the temperature threshold range or above or below the temperature threshold. In certain embodiments, when the temperature is at or above a temperature threshold range, the process may proceed to block 306.

Moreover, in certain embodiments, the processor 290 may make a determination of whether to modify an operation of the deposition system 260 based on the measured temperature being above or below multiple temperature thresholds and/or multiple temperature threshold ranges. For example, the processor 290 may output one of multiple control signals to control operation of the substrate cooling devices 282, the rotation actuator 300, axial translation of the thermal spray device 264, the thermal spray device 264, and the like, based on whether the measured temperature is within one of multiple temperature ranges. That is, when processor 290 receives a measured temperature that is within a first temperature threshold range, the processor 290 may output a control signal to the substrate cooling devices 282 to begin a cooling process. When the processor 290 receives a measured temperature that is within a second temperature threshold range (e.g., having a temperature range that is above or below the first temperature threshold range), the processor 290 may output a control signal to modify the amount of cooling provided by the substrate cooling devices (e.g., increasing and/or decreasing flow rate, increasing and/or decreasing flow temperature, and/or changing from active cooling to passive cooling, as discussed in more detail below). When the processor 290 receives a measured temperature that is within a third temperature threshold range, the processor 290 may output a control signal to activate the thermal spray device 264, the rotation actuator 300, and/or cause the thermal spray device 264 and/or the lower inner radial bearing 230 to translate axially. When the processor 290 receives a measured temperature that is within a fourth temperature threshold range (e.g., that is above the third temperature range), the processor 290 may output a control signal to halt operation of the thermal spray device 264, the rotation actuator 300, and/or halt axial translation of the thermal spray device 264. While the above discussion is related to the measured temperature being within multiple temperature threshold ranges, it should be noted that the above discussion may also apply to the measured temperature being above and/or below multiple temperature thresholds.

Cooling the radial bearing 222 (block 306) may include active cooling, passive cooling, or any combination thereof. Actively cooling the radial bearing 222 (block 306) may include the processor 290 outputting an additional control signal to the substrate cooling device(s) 282 (e.g., a cooling jet) that modifies operation of the substrate cooling device(s) 282. For example, modifying operation of the substrate cooling device(s) 282 may include activating the substrate cooling device(s) 282 to provide the cooling flow(s) 284 and/or modifying a magnitude of the cooling flow(s) 284 (e.g., increasing a fan speed or modifying a temperature). In certain embodiments, the cooling flow(s) 284 may be provided during the deposition of the first layer, during deposition of the second layer, or both. For example, cooling the radial bearing 222 may include blowing the cooling flow(s) 284 onto a surface of the radial bearing 222 that is receiving the air (or oxygen) and fuel gas mixture from the thermal spraying device 264 (e.g., the portion 307). In certain embodiments, the passively cooling of the radial bearing 222 (block 306) may include halting operation of the thermal spraying device 264 for a predetermined time, such as a suitable time for the temperature of the radial bearing 222 to be brought to or below a temperature threshold and/or within a temperature threshold range. In certain embodiments, the operation of the thermal spraying device 264 may be halted until the processor 290 determines that the temperature of the radial bearing 222 is below the temperature threshold and/or within the temperature threshold range based on a measured temperature obtained by the temperature sensor 298.

For example, when the substrate 262 and/or the radial bearing 222 has relatively long dimensions (e.g., greater than 15, 18, or 20 inches), the temperature of the substrate 262 may cool and be below the temperature threshold by the time the first layer is deposited across the length of the substrate 262. As such, in at least some instances, halting operation of the thermal spraying device 264 and/or pausing between and/or during deposition steps (e.g., blocks 312 and/or 316) may not be necessary. However, it should be noted that if the substrate and/or radial bearing 222 has relatively short dimensions (e.g., less than 20 inches), a temporal break (e.g., a pause) between and/or during the deposition steps (blocks 312 and 316) may prevent overheating of the substrate 262. For example, certain radial bearings 222 may have a length of 20 inches or even shorter and, therefore, under certain operating conditions, the temporal break for a predetermined time period (e.g., 10 seconds, 30 seconds, 1 minute, 2 minutes, etc.) between and/or during the deposition steps may prevent the radial bearing 222 from overheating (e.g., heating above a temperature threshold).

After the first layer of the material coating 240 is deposited onto the radial bearing 222, a second layer of the material coating 240 may be deposited. In certain embodiments, the second layer may be deposited adjacent to the first layer. For example, in an embodiment where the radial bearing 222 is rotating while the material coating 240 is being deposited onto the radial bearing 222, the thermal spraying device 264 may deposit the first layer over the portion 307 of the surface of the radial bearing 222 corresponding to a degree of rotation by the radial bearing 222. Then, the thermal spraying device 264 may deposit the second layer over an additional portion of the surface of the radial bearing 222 corresponding to a subsequent degree of rotation by the radial bearing 222. In certain embodiments, the second layer may be deposited on, or at least partially on, the first layer. For example, the first layer may be deposited on the outer surface 250 of the lower inner radial bearing 230 as the thermal spray device 264 translates axially in the direction 306, and the second layer may be deposited on the outer surface 250 of the lower inner radial bearing 230 as the thermal spray device 264 translates axially in the direction 306 and/or opposite of the direction 306. Accordingly, each layer may correspond to a fraction of a predetermined thickness 280 of the material coating 240. In some embodiments, each layer of the material coating 240 may be between 0.001 to 0.003 inches, between 0.015 to 0.025 inches, or approximately 0.002 inches thick.

In certain embodiments, additional (e.g., 1, 2, 3, 4, 5, or even more) layers of the material coating 240 may be deposited onto the radial bearing 222. Accordingly, the radial bearing 222 may be cooled one or more times, during and/or in between each deposition step of the material coating 240. Once a predetermined number of layers of the material coating 240 are deposited onto the radial bearing 222, one or more conclusion steps may be performed on the radial bearing 222, such as polishing or smoothing the radial bearing 222 to the desired thickness 280. At least in some instances, polishing the radial bearing 222 with the material coating 240 deposited thereon may further reduce time associated with preparing the radial bearing 222 as compared to certain conventional techniques.

Accordingly, the present disclosure relates to techniques for performing a deposition process of a material using a thermal spray process. The disclosed deposition processes to produce a substrate with a material coating generally include one or more deposition steps using thermal spraying, one or more cooling steps, and, at least in some instances, conclusion steps, such as polishing of the material coating deposited onto the substrate. For example, the disclosed processes may include depositing a first layer of a material coating onto a surface of a radial bearing, cooling the radial bearing, and depositing a second layer of the material coating onto the surface after the first layer is deposited. In certain embodiments, cooling the radial bearing may be a continuous cooling, such as by providing an active cooling flow of a fluid to the radial bearing during the deposition. Additionally or alternatively, cooling the radial bearing may include passive cooling with one or more temporal breaks between depositing the first layer and the second layer. By using thermal spraying in combination with the cooling steps, certain materials (e.g., carbides, such as tungsten carbides) may be deposited on various substrates with less material oxidation and precursor (e.g., carbide) decomposition with more resistance to corrosion, higher hardness, and toughness and, at least in some instances, with thinner layers of the material coating. As such, the disclosed techniques may reduce costs associated with coating substrates by using less material. Additionally, the disclosed techniques may have a decreased lead time over certain conventional substrate coating processes, such as “cloth” coating of radial bearings for drilling rigs and the like.

The specific embodiments described herein have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A method, comprising:
depositing a first layer of a material coating upon a substrate using a thermal spray device;
providing a cooling flow to the substrate via a cooling jet; and
depositing a second layer of the material coating upon the substrate using the thermal spray device, wherein the second layer is deposited subsequent to depositing the first layer.

2. The method of claim 1, wherein the thermal spray device comprises high velocity air fuel (HVAF) thermal spray device.

3. The method of claim 1, wherein the cooling flow is provided during the depositing of the first layer, during the depositing of the second layer, or both.

4. The method of claim 1, wherein depositing the first layer comprises:
adding a material coating precursor powder to a fuel gas at a nozzle of the thermal spray device;
adding air or oxygen to a mixture of the material coating precursor powder and the fuel gas at the nozzle to form an air/oxygen fuel gas mixture; and
impinging the air/oxygen fuel gas mixture onto a surface of the substrate to be coated until the first layer of the material coating has a desired thickness.

5. The method of claim 1, comprising:
measuring a temperature of the substrate while depositing the first layer of the material; and
depositing the second layer of the material based at least in part on the measured temperature.

6. The method of claim 5, comprising:
providing the cooling flow to the substrate when the temperature of the substrate exceeds a temperature threshold; and
depositing the second layer of the material after providing the cooling flow.

7. The method of claim 5, comprising depositing the second layer of the material when the measured temperature is below a temperature threshold.

8. The method of claim 1, wherein depositing the first layer of the material comprises rotating the substrate about a longitudinal axis of the substrate.

9. The method of claim 1, wherein the second layer is deposited at least partially on top of the first layer.

10. The method of claim 1, wherein the substrate is a radial bearing, and wherein depositing the first layer comprises rotating the radial bearing while depositing the first layer and depositing the second layer comprises rotating the radial bearing while depositing the second layer.

11. A method, comprising:
depositing a first layer of a material coating on a radial bearing using a thermal spray device;
cooling the radial bearing; and
depositing a second layer of the material coating on the radial bearing using the thermal spray device.

12. The method of claim 11, wherein the material coating comprises a metal carbide.

13. The method of claim 11, comprising:
rotating the radial bearing about a longitudinal axis of the radial bearing; and
depositing the first layer while the radial bearing is rotating.

14. The method of claim 11, wherein cooling the radial bearing comprises pausing for a predetermined time period before depositing the second layer of the material coating.

15. The method of claim 11, wherein cooling the radial bearing comprises providing a cooling flow using a cooling jet to prevent a temperature of the radial bearing from exceeding a temperature threshold.

16. The method of claim 11, wherein cooling the radial bearing occurs during the depositing the first layer of the material coating, during the depositing the second layer of the material coating, or both.

17. The method of claim 11, comprising:
measuring a temperature of the radial bearing while depositing the first layer of the material coating, while depositing the second layer of the material coating, or both; and
cooling the radial bearing when the measured temperature exceeds a temperature threshold.

18. A system, comprising:
a high velocity air fuel (HVAF) thermal spray device configured to provide a material spray to a radial bearing to form a material coated radial bearing;
a cooling jet configured to provide a cooling flow of fluid to the radial bearing;
a rotational actuator configured to rotate the radial bearing; and
a controller communicatively coupled to the rotational actuator, the HVAF thermal spray device, and the cooling jet, wherein the controller is configured to:
send a first control signal to the HVAF thermal spray device to provide the material spray;
send a second control signal to the rotational actuator to rotate the radial bearing;
and
send a third control signal to cause the cooling jet to provide the cooling flow of the fluid

19. The system of claim 18, comprising one or more temperature sensors configured to measure a temperature of the radial bearing, wherein the controller is configured to send the third control signal to cause the cooling jet to provide the cooling flow of the fluid when the measured temperature is above a temperature threshold range.

20. The system of claim 19, wherein the controller is configured to adjust the first control signal based at least in part on the measured temperature.
